(19) United States
(12) Patent Application Publication
(10) Pub. No.: US 2026/0008458 A1
(43) Pub. Date: Jan. 8, 2026

(54) DRIVER-ASSISTANCE APPARATUS AND METHOD FOR A VEHICLE

(71) Applicant: Bendix Commercial Vehicle Systems LLC, Avon, OH (US)

(72) Inventors: Thomas S. Miller, Lagrange, OH (US); Victoria Yee, North Olmsted, OH (US); David J. Taneyhill, Vermillion, OH (US); Javier A. Ruiz, Lakewood, OH (US); Khaja Sharfuddin Mohammed, Bellingham, WA (US); Antonio Rocco, Kent, OH (US)

(21) Appl. No.: 18/765,803

(22) Filed: Jul. 8, 2024

(51) Int. Cl. B60W 30/12; B60W 10/20; B60W 50/14; B60W 50/16; G01S 13/931

(52) U.S. Cl. CPC B60W 30/12; B60W 10/20; B60W 50/16; B60W 2050/143; B60W 2050/146; G01S 2013/93271; G01S 2013/93274

(57) ABSTRACT

A driver-assistance apparatus is provided for a vehicle. The driver-assistance apparatus comprises a stability control program arranged to provide vehicle stability during operation of the vehicle. The driver-assistance apparatus also comprises a first lane-aligning program arranged to maintain the vehicle substantially at center of a road lane during operation of the vehicle, and a second lane-aligning program arranged to maintain the vehicle substantially at outer edges of a road lane during operation of the vehicle. The driver-assistance apparatus further comprises a vehicle controller arranged to switch from the first lane-aligning program to the second lane-aligning program when the first lane-aligning program is running and the stability control program is invoked as the first lane-aligning program is running.

### BACKGROUND

The present application relates to vehicle driver-assistance systems, and is particularly directed to a driver-assistance apparatus and method for a vehicle, such as a truck.

Driver-assistance systems for trucks are known. One type of driver-assistance system for trucks includes a vehicle stability control program in which vehicle factors, such as vehicle ground speed and vehicle engine torque, are reduced to reduce tendency of the vehicle to rollover or jackknife. The vehicle stability control program is responsive to signals from various vehicle sensors, such as yaw sensors and lateral acceleration sensors.

Another type of driver-assistance system for trucks includes a lane-aligning assist program in which correct lateral position of the vehicle is maintained to maintain the vehicle in a vehicle driving lane. The lane-aligning assist program is responsive to signals from various vehicle sensors, such as cameras and radars.

Despite advancements already made, those skilled in the art continue with research and development efforts in the field of vehicle driver-assistance systems, such as those used in trucks.

### SUMMARY

In accordance with one embodiment, a driver-assistance apparatus is provided for a vehicle. The driver-assistance apparatus comprises a stability control program arranged to provide vehicle stability during operation of the vehicle. The driver-assistance apparatus also comprises a first lane-aligning program arranged to maintain the vehicle substantially at center of a road lane during operation of the vehicle, and a second lane-aligning program arranged to maintain the vehicle substantially at outer edges of a road lane during operation of the vehicle. The driver-assistance apparatus further comprises a vehicle controller arranged to switch from the first lane-aligning program to the second lane-aligning program when the first lane-aligning program is running and the stability control program is invoked as the first lane-aligning program is running.

In accordance with another embodiment, a driver-assistance apparatus is provided for a vehicle. The driver-assistance apparatus comprises a lane-centering assist program, and a lane-keeping assist program. The driver-assistance apparatus also comprises means for, without vehicle driver intervention, automatically switching from the lane-centering assist program to the lane-keeping program when the lane-centering assist program is running and a vehicle stability control program is invoked as the lane-centering assist program is running.

In accordance with yet another embodiment, a method is provided for a vehicle having stability control arranged to provide vehicle stability during operation of the vehicle. The method comprises switching from a first lane-aligning program to a second lane-aligning program when the first lane-aligning program is running and stability control is invoked as the first lane-aligning program is running.

### BRIEF DESCRIPTION OF THE DRAWINGS

FIG. 1 is a schematic block diagram showing an example driver-assistance apparatus constructed in accordance with an embodiment.

FIG. 2 is a flow diagram depicting an example method of operating the driver-assistance apparatus of FIG. 1 in accordance with an embodiment.

FIG. 3 is a flow diagram depicting an example method of operating the driver-assistance apparatus of FIG. 1 in accordance with another embodiment.

FIG. 4 is a flow diagram depicting an example method of operating the driver-assistance apparatus of FIG. 1 in accordance with yet another embodiment.

### DETAILED DESCRIPTION

The present application is directed to a driver-assistance apparatus for a vehicle. The specific construction of the driver-assistance apparatus may vary. It is to be understood that the disclosure below provides a number of embodiments or examples for implementing different features of various embodiments. Specific examples of components and arrangements are described to simplify the present disclosure. These are merely examples and are not intended to be limiting.

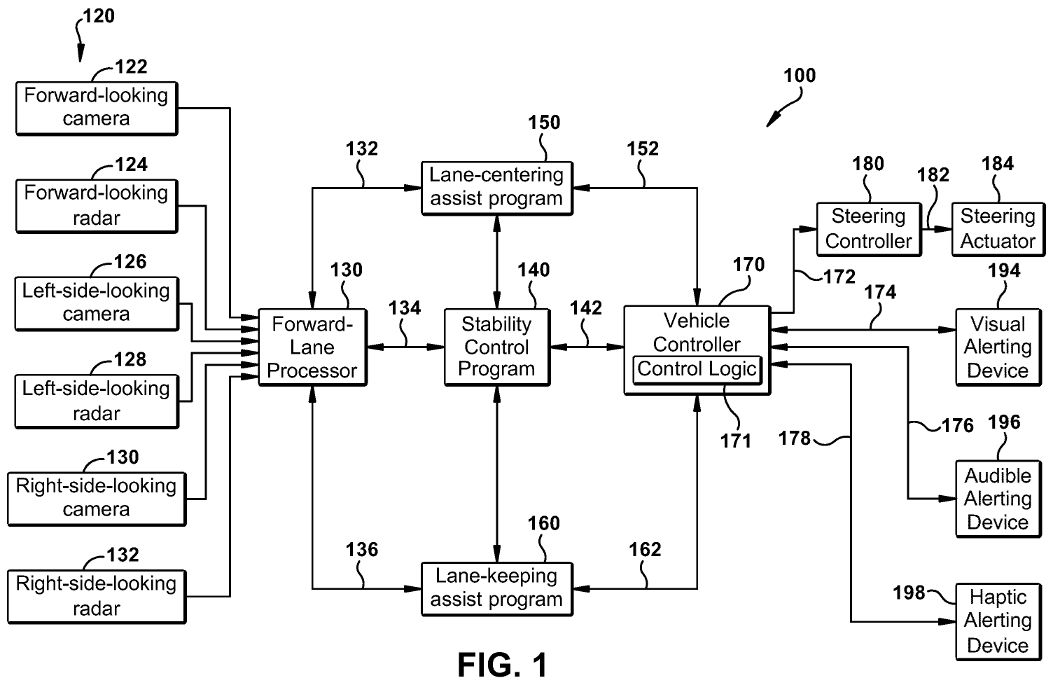

Referring to FIG. 1, a schematic block diagram showing an example driver-assistance apparatus 100 constructed in accordance with an embodiment is illustrated. The driver-assistance apparatus 100 can be embodied in a vehicle (not shown) such as a truck.

Driver-assistance apparatus 100 includes a number of devices 120 that cooperate together to provide a plurality of output signals indicative of a corresponding plurality of traffic factors surrounding the vehicle. The devices 120 include but are not limited to traffic measurement devices, such as a forward-looking camera 122 and a forward-looking radar 124. Optionally, the devices 120 include a left-side-looking camera 126, a left-side-looking radar 128, a right-side-looking camera 130, and a right-side-looking radar 132. Each of the devices 120 provides a corresponding output signal indicative of a traffic factor surrounding the vehicle.

The forward-looking camera 122 and the forward-looking radar 124 cooperate together to provide one or more output signals indicative of one or more traffic factors associated with any vehicle that may be traveling in front of and in the same lane as the vehicle. The left-side-looking camera 126 and the left-side-looking radar 128 cooperate together to provide one or more output signals indicative of one or more traffic factors associated with any vehicle that may be traveling in an adjacent lane on the left-side of the vehicle. Similarly, the right-side-looking camera 130 and the right-side-looking radar 132 cooperate together to provide one or more output signals indicative of one or more traffic factors associated with any vehicle that may be traveling in an adjacent lane on the right-side of the vehicle.

The driver-assistance apparatus 100 also includes a forward-lane processor 130 that monitors the output signals from the devices 120. The forward-lane processor 130 may comprise any type of processing technology. For example, the forward-lane processor 130 may comprise a general-purpose electronic processor. Other types of processor technologies are possible.

The devices 120 may be hardwired or communicate via a controller area network (CAN) bus, or a combination of both, to the forward-lane processor 130. The forward-lane processor 130 executes instructions stored in internal data memory (not shown) to process the output signals from the devices 120, and to provide control signals on lines 132, 136 based upon the output signals from the devices 120. Optionally, the forward-lane processor 130 provides control signals on line 134. Structure and operation of the devices 120 and the forward-lane processor 130 are known and conventional and, therefore, will not be described.

The driver-assistance apparatus 100 includes a stability control program 140 that is arranged to provide vehicle stability during operation of the vehicle. In particular, the stability control program 140 provides yaw control and roll control during operation of the vehicle. An example of the stability control program 140 is an electronic stability control (ESC), such as the Bendix® ESP® system, commercially available from Bendix Commercial Vehicle Systems, LLC located in Avon, Ohio.

The driver-assistance apparatus 100 further includes a lane-centering assist program 150 and a lane-keeping assist program 160. Each of the programs 150, 160 is a lane-aligning program that assists the vehicle driver in maintaining the vehicle aligned within predefined limits in the current lane of the vehicle. In particular, the lane-centering assist program 150 (i.e., a first lane-aligning program) attempts to keep the vehicle at or very near the center of the current lane as defined by a combination of lane lines and road boundary information as detected by the devices 120. In contrast, the lane-keeping assist program 160 (i.e., a second lane-aligning program) attempts to keep the vehicle at or slightly beyond outer edges of the current lane as defined by a combination of lane lines and road boundary information as detected by the devices 120. The lane-keeping assist program 160 allows more lateral displacement within the current lane than the lane-centering program 150. Structure and operation of known lane-centering assist programs and lane-keeping assist programs are commercially available and, therefore, will not be further described.

It should be apparent that the forward-lane processor 130 monitors the output signals from the combination of the forward-looking camera 122, the forward-looking radar 124, the left-side-looking camera 126, the left-side-looking radar 128, the right-side-looking camera 130, and the right-side-looking radar 132 to provide a number of output signals to the lane-centering assist program 150 and the lane-keeping assist program 160.

Driver-assistance apparatus 100 also includes a vehicle controller 170 in the form of an electronic controller unit that is arranged to monitor control output signals on lines 142, 152, 162, respectively, from the stability control program 140, the lane-centering assist program 150, and the lane-keeping assist program 160. The vehicle controller 170 in turn provides one or more control output signals on lines 172, 174, 176, 178 based upon control logic 171 that is stored in a data storage unit of the vehicle controller 170. In some implementations, the vehicle controller 170 may comprise the controller that is used in the Bendix Fusion™ advanced driver assistance system, commercially available from Bendix Commercial Vehicle Systems, LLC located in Avon, Ohio.

As shown in FIG. 1, the vehicle controller 170 provides control output signals on line 172 to a steering controller 180. The steering controller 180 is arranged to provide a control output signal on line 182 to control a steering actuator 184 of the vehicle in response to a control output signal on line 172 from the vehicle controller 170. The vehicle controller 170 also provides control output signals on line 174 to one or more visual alerting devices 194, control output signals on line 176 to one or more audible alerting devices 196, and control output signals on line 178 to one or more haptic alerting devices 198. The combination of the visual alerting devices 194, the audible alerting devices 196, and the haptic alerting devices 198 are arranged to alert the vehicle driver when the vehicle controller 170 transitions (i.e., switches) from running the lane-centering assist program 150 to running the lane-keeping assist program, as will be described herein.

In accordance with an aspect of the present disclosure, the vehicle controller 170 is arranged to switch from the first lane-aligning program (i.e., the lane-centering assist program 150) to the second lane-aligning program (i.e., the lane-keeping assist program 160) when the first lane-aligning program 150 is running and the stability control program 140 is invoked as the first lane-aligning program 150 is running. Notably, the switching occurs automatically, without vehicle driver intervention, from the lane-centering assist program 150 to the lane-keeping assist program 160 when the lane-centering assist program 150 is running and the stability control program 140 is invoked as the lane-centering assist program 150 is running.

A number of advantages result by switching from running the lane-centering assist (LCA) program 150 to running the lane-keeping assist (LKA) program 160 when the stability control program 140 is invoked as the LCA program 150 is running. One advantage is that a larger turning radius is provided by the LKA program 160 since the LKA program 160 allows more lateral displacement within a curved road lane than the LCA program 150. The higher lateral displacement within the curved road lane results in lower lateral acceleration acting on the vehicle as the vehicle turns through the curved road lane with the larger turning radius. The lower lateral acceleration acting on the vehicle reduces the likelihood of a vehicle rollover as the vehicle is turning through the curved road lane.

Another advantage is that the activation of the LKA program 160 (i.e., when the LCA program 150 is deactivated in response to the stability control program 140 being invoked) provides at least some lane-aligning assistance for the vehicle driver even after the LCA program 150 is deactivated and no longer provides any lane-aligning assistance for the vehicle driver. As an example, the activation of the LKA program 160 may provide corrective action (via the vehicle controller 170 and the steering controller 180 to the steering actuator 184), without vehicle driver intervention, for either an understeering condition or an oversteering condition of the vehicle as the vehicle is turning through the curved road lane. The result is improved understeer yaw control and improved oversteer yaw control of the vehicle as the vehicle is turning through the curved road lane.

In particular, when the stability control program 140 activates, the transitioning to the LKA program 160 allows for the vehicle to follow the larger radius of curvature of the outside of the lane. This larger radius of curvature results in a reduced steering angle input. When the steering angle input is reduced, the yaw rate demanded by the steering input is reduced, which is directionally correct steering input for mitigating vehicle oversteer. Also, the lateral acceleration is reduced, which helps to mitigate vehicle rollover. Moreover, the reduced steering angle brings the steer axle road wheel angle back towards the point where peak lateral force is available, which is one way to mitigate vehicle understeer.

Yet another advantage is that the LKA program 160 may remain available for the vehicle driver for a longer time.

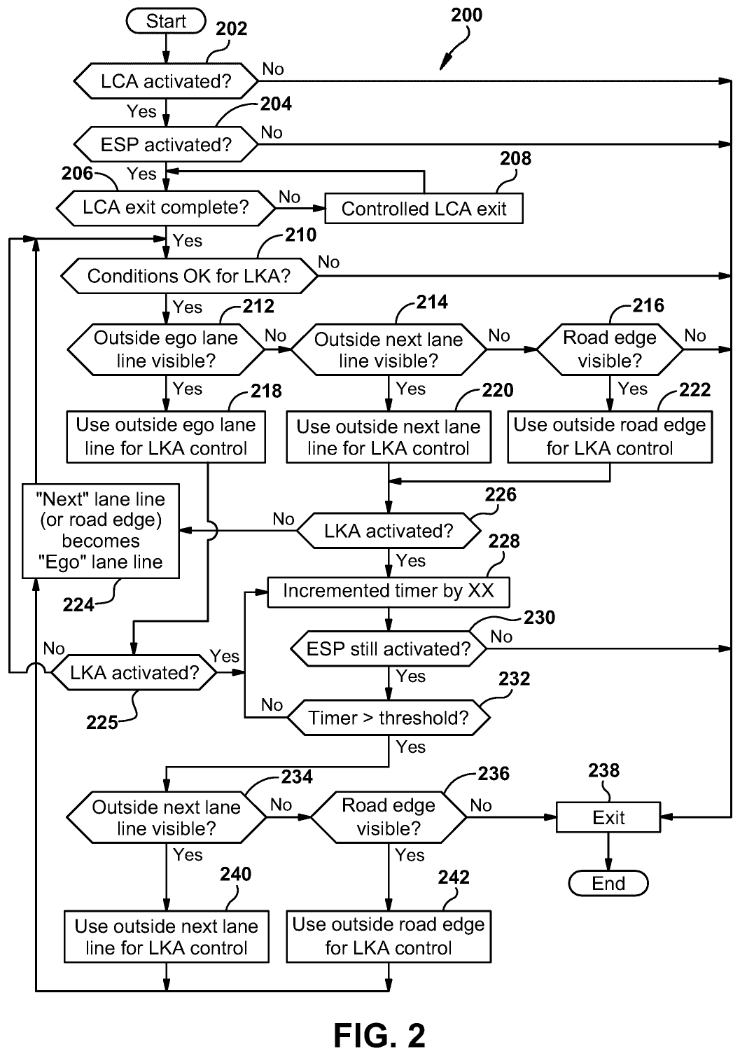

Referring to FIG. 2, a flow diagram 200 depicts an example method of operating the driver-assistance apparatus 100 of FIG. 1 in accordance with an embodiment. In block 202, a determination is made as to whether the LCA program 150 is activated (i.e., running). If the determination in block 202 is negative, the process proceeds to block 238 in which the routine is exited before the process ends.

However, if the determination in block 202 is affirmative, the process proceeds to block 204. In block 204, a determination is made as to whether the stability control program 140 (e.g., ESP) is activated. If the determination in block 204 is negative, the process proceeds to block 238 in which the routine is exited before the process ends. However, if the determination in block 204 is affirmative, the process proceeds to block 206 in which a determination is made as to whether exiting of the LCA program 150 is complete.

If the determination in block 206 is negative, the process proceeds to block 208 in which exiting of the LCA program 150 is controlled. The exiting of the LCA program 150 is controlled such that trajectory of the vehicle is located near the outside lane line of the target lane (ego lane, next lane, etc.). Final point is a position at or near the activation conditions for the LKA program 160 for the outside target lane line. However, if the determination in block 206 is affirmative, the process proceeds to block 210.

In block 210, a determination is made as to whether conditions are okay for the LKA program 160. If the determination in block 210 is negative, the process proceeds to block 238 in which the routine is exited before the process ends. However, if the determination in block 210 is affirmative, the process proceeds to block 212.

In block 212, a determination is made as to whether an outside ego lane line is visible. If the determination in block 212 is affirmative, the process proceeds to block 218 in which the outside ego lane line is used for LKA control before proceeding to block 225. In block 225, a determination is made as to whether the LKA program 160 is activated. If the determination in block 225 is negative, the process returns back to block 210. However, if the determination in block 225 is affirmative, the process proceeds to block 228 in which a timer is incremented by XX before proceeding to block 230. However, if the determination back in block 212 is negative, the process proceeds to block 214 in which a determination is made as to whether an outside next lane line is visible.

If the determination in block 214 is affirmative, the process proceeds to block 220 in which the outside next lane line is used for LKA control before proceeding to block 226. However, if the determination in block 214 is negative, the process proceeds to block 216 in which a determination is made as to whether a road edge is visible.

If the determination in block 216 is affirmative, the process proceeds to block 222 in which the outside road edge is used for LKA control before proceeding to block 226. However, if the determination in block 216 is negative, the process proceeds to block 238 in which the routine is exited before the process ends.

In block 226, a determination is made as to whether the LKA program 160 is activated. If the determination in block 226 is negative, the process proceeds to block 224 in which the “next” lane line (or road edge) becomes the “ego” lane line at some point as the vehicle moves outward. The process then returns back to block 210. However, if the determination in block 226 is affirmative, the process proceeds to block 228 in which a timer is incremented by XX before proceeding to block 230.

In block 230, a determination is made as to whether the stability control program 140 is still activated. If the determination in block 230 is negative, the process proceeds to block 238 in which the routine is exited before the process ends. However, if the determination in block 230 is affirmative, the process proceeds to block 232 in which a determination is made as to whether the timer in block 228 is greater than a threshold. If the determination in block 232 is negative, the process loops back to block 228 to continue incrementing the timer. However, if the determination in block 232 is affirmative, the process proceeds to block 234.

In block 234, a determination is made as to whether an outside next lane line is visible. If the determination in block 234 is affirmative, the process proceeds to block 240 in which the outside next lane line is used for LKA control before proceeding to block 224. In block 224, the “next” lane line (or road edge) becomes the “ego” lane line at some point as the vehicle moves outward. The process then returns back to block 210. However, if the determination in block 234 is negative, the process proceeds to block 236 in which a determination is made as to whether a road edge is visible.

If the determination in block 236 is affirmative, the process proceeds to block 242 in which the outside road edge is used for LKA control before proceeding to block 224. In block 224, the “next” lane line (or road edge) becomes the “ego” lane line at some point as the vehicle moves outward. The process then returns back to block 210. However, if the determination in block 236 is negative, the process proceeds to block 238 in which the routine is exited before the process ends.

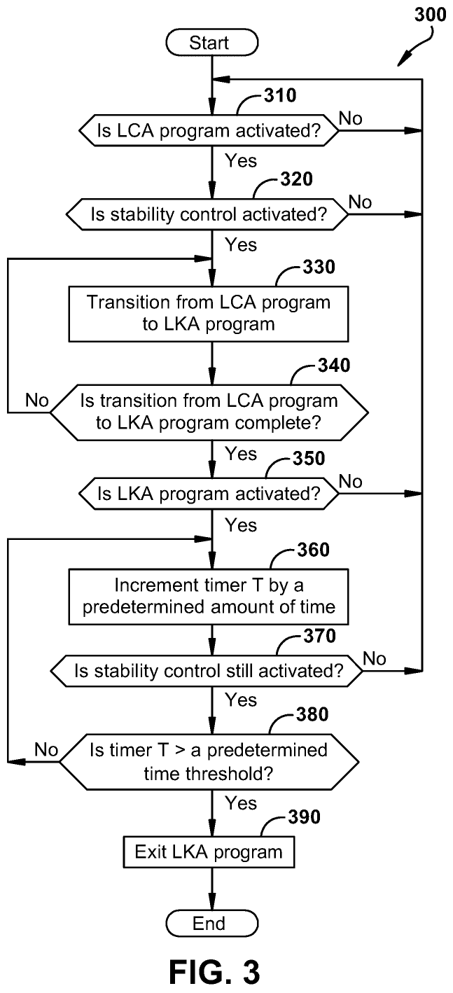

Referring to FIG. 3, a flow diagram 300 depicts an example method of operating the driver-assistance apparatus 100 of FIG. 1 in accordance with another embodiment. In block 310, a determination is made as to whether the LCA program 150 is activated (i.e., running). If the determination in block 310 is negative (i.e., the LCA program 150 is not activated), the process loops back to block 310 to continue monitoring if the LCA program 150 is activated. However, if the determination in block 310 is affirmative (i.e., the LCA program 150 is activated), the process proceeds to block 320.

In block 320, a determination is made as to whether stability control is activated. If the determination in block 320 is negative (i.e., stability control is not activated), the process loops back to block 310 to continue monitoring if the LCA program 150 is activated. However, if the determination in block 320 is affirmative (i.e., stability control is activated), the process proceeds to block 330.

In block 330, the vehicle controller 170 stops running of the LCA program 150, and transitions to running the LKA program 160. The process then proceeds to block 340 in which a determination is made as to whether the transition of running the LCA program 150 to running the LKA program 160 is completed. If the determination in block 340 is negative (i.e., the transition is not completed), the process loops back to block 330 to continue transitioning from the LCA program 150 to the LKA program 160. However, if the determination in block 340 is affirmative (i.e., the transition is completed), the process proceeds to block 350.

In block 350, a determination is made as to whether the LKA program 160 is activated. If the determination in block 350 is negative (i.e., the LKA program 160 is not activated), the process loops back to block 310 to continue monitoring if the LCA program 150 is activated. However, if the determination in block 350 is affirmative (i.e., the LKA program 160 is activated), the process proceeds to block 360.

In block 360, a timer T is incremented by a predetermined amount of time. As an example, the predetermined amount of time may comprise a time value that is between about 0.25 second and about 1.00 second. The process then proceeds to block 370 in which a determination is made as to whether stability control is still activated. If the determination in block 370 is negative (i.e., stability control is no longer activated), the process loops back to block 310 to continue monitoring if the LCA program 150 is activated. However, if the determination in block 370 is affirmative (i.e., stability control is still activated), the process proceeds to block 380.

In block 380, a determination is made as to whether the time value of the timer T is greater than a predetermined time threshold. As an example, the predetermined time threshold may comprise a time threshold value that is between about 0.50 second and about five seconds. If the determination in block 380 is negative (i.e., the time value of the timer T is less than the predetermined time threshold), the process loops back to block 360 to increment the timer T by another predetermined amount of time. However, if the determination in block 380 is affirmative (i.e., the time value of the timer T is greater than the predetermined time threshold), the process proceeds to block 390 in which the LKA program 160 exits (i.e., the vehicle controller 170 stops running the LKA program 160). The process then ends, or alternatively, may loop back to block 310 to monitor if the LCA program 150 is activated.

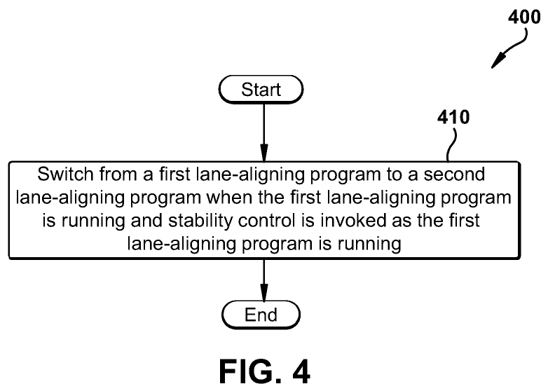

Referring to FIG. 4, a flow diagram 400 depicts an example method of operating the driver-assistance apparatus 100 of FIG. 1 in accordance with yet another embodiment. In block 410, a first lane-aligning program is switched to a second lane-aligning program when the first lane-aligning program is running and stability control is invoked as the first lane-aligning program is running. The process then ends.

In some embodiments, the method further comprises controlling a steering actuator in response to switching from the first lane-aligning program to the second lane-aligning program.

In some embodiments, the method further comprises alerting a vehicle driver when the first lane-aligning program is switched to the second lane-aligning program. In some embodiments, the vehicle driver is alerted with a combination of visual alerts, audible alerts, and haptic alerts when the first lane-centering program is switched to the second lane-centering program.

In some embodiments, the method further comprises monitoring a number of signals received from a combination of a forward-looking camera and a forward-looking radar to provide a number of signals to the first lane-aligning program and the second lane-aligning program. In some embodiments, the method further comprises monitoring a number of signals received from a combination of a left-side-looking camera, a left-side-looking radar, a right-side-looking camera, and a right-side-looking radar to provide a number of signals to the first lane-aligning program and the second lane-aligning program.

In some embodiments, the method is performed by a computer having a memory executing one or more programs of instructions which are tangibly embodied in a program storage medium readable by the computer.

Program instructions (e.g., the control logic 171 shown in FIG. 1) for enabling the vehicle controller 170 to perform operation steps in accordance with flow diagram 200 shown in FIG. 2, flow diagram 300 shown in FIG. 3, or flow diagram 400 shown in FIG. 4 may be embedded in memory internal to vehicle controller 170. Alternatively, or in addition to, program instructions may be stored in memory external to vehicle controller 170. As an example, program instructions may be stored in memory internal to a different electronic controller of the vehicle. Program instructions may be stored on any type of program storage media including, but not limited to, external hard drives, flash drives, and compact discs. Program instructions may be reprogrammed depending upon features of the particular electronic controller.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although the above-description describes use of two electronic controllers (i.e., the vehicle controller 170 and the steering controller 180), it is conceivable that any number of electronic controllers may be used. For example, the two electronic controllers 170, 180 may comprise a single-integrated electronic controller. Moreover, it is conceivable that any type of electronic controller may be used. Suitable electronic controllers for use in vehicles are known and, therefore, have not been described. Accordingly, the program instructions of the present disclosure can be stored on program storage media associated with one or more electronic controllers.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A driver-assistance apparatus for a vehicle, the driver-assistance apparatus comprising:
a stability control program arranged to provide vehicle stability during operation of the vehicle;
a first lane-aligning program arranged to maintain the vehicle substantially at center of a road lane during operation of the vehicle;
a second lane-aligning program arranged to maintain the vehicle substantially at outer edges of a road lane during operation of the vehicle; and
a vehicle controller arranged to switch from the first lane-aligning program to the second lane-aligning program when the first lane-aligning program is running and the stability control program is invoked as the first lane-aligning program is running.

2. A driver-assistance apparatus according to claim 1, wherein (i) the first lane-aligning program comprises a lane-centering assist program, and (ii) the second lane-aligning program comprises a lane-keeping assist program.

3. A driver-assistance apparatus according to claim 1 further comprising:
a combination of a forward-looking camera and a forward-looking radar.

4. A driver-assistance apparatus according to claim 3 further comprising:
a combination of a left-side-looking camera, a left-side-looking radar, a right-side-looking camera, and a right-side-looking radar.

5. A driver-assistance apparatus according to claim 3 further comprising:
a processor for monitoring a number of signals received from the combination of a forward-looking camera and a forward-looking radar to provide a number of signals to the first lane-aligning program and the second lane-aligning program.

6. A driver-assistance apparatus according to claim 1 further comprising:
a steering actuator;
a steering controller arranged to control the steering actuator in response to a control signal from the vehicle controller.

7. A driver-assistance apparatus according to claim 1 further comprising:
a number of driver-alerting devices arranged to alert a vehicle driver when the first lane-aligning program is switched to the second lane-aligning program.

8. A driver-assistance apparatus according to claim 7, wherein the number of driver-alerting devices includes a combination of visual alerting devices, audible alerting devices, and haptic alerting devices.

9. A driver-assistance apparatus according to claim 1, wherein the stability control program comprises a combination of a roll control and a yaw control.

10. A driver-assistance apparatus for a vehicle, the driver-assistance apparatus comprising:
a lane-centering assist program;
a lane-keeping assist program; and
means for, without vehicle driver intervention, automatically switching from the lane-centering assist program to the lane-keeping program when the lane-centering assist program is running and a vehicle stability control program is invoked as the lane-centering assist program is running.

11. A driver-assistance apparatus according to claim 10 further comprising:
a combination of a forward-looking camera and a forward-looking radar.

12. A driver-assistance apparatus according to claim 11 further comprising:
a combination of a left-side-looking camera, a left-side-looking radar, a right-side-looking camera, and a right-side-looking radar.

13. A driver-assistance apparatus according to claim 11 further comprising:
a processor for monitoring a number of signals received from the combination of a forward-looking camera and a forward-looking radar to provide a number of signals to the lane-centering assist program and the lane-keeping assist program.

14. A driver-assistance apparatus according to claim 10 further comprising:
a steering actuator;
a steering controller arranged to control the steering actuator when the lane-centering assist program is automatically switched to the lane-keeping assist program.

15. A driver-assistance apparatus according to claim 10 further comprising:
a number of driver-alerting devices arranged to alert a vehicle driver when the lane-centering assist program is automatically switched to the lane-keeping assist program.

16. A driver-assistance apparatus according to claim 15, wherein the number of driver-alerting devices includes a combination of visual alerting devices, audible alerting devices, and haptic alerting devices.

17. A method for a vehicle having stability control arranged to provide vehicle stability during operation of the vehicle, the method comprising:
switching from a first lane-aligning program to a second lane-aligning program when the first lane-aligning program is running and stability control is invoked as the first lane-aligning program is running.

18. A method according to claim 17 further comprising:
controlling a steering actuator in response to switching from the first lane-aligning program to the second lane-aligning program.

19. A method according to claim 17 further comprising:
alerting a vehicle driver when the first lane-aligning program is switched to the second lane-aligning program.

20. A method according to claim 19 wherein alerting a vehicle driver when the first lane-aligning program is switched to the second lane-aligning program includes:
alerting the vehicle driver with a combination of visual alerts, audible alerts, and haptic alerts when the first lane-centering program is switched to the second lane-centering program.

21. A method according to claim 17 further comprising:
monitoring a number of signals received from a combination of a forward-looking camera and a forward-looking radar to provide a number of signals to the first lane-aligning program and the second lane-aligning program.

22. A method according to claim 21 further comprising:
monitoring a number of signals received from a combination of a left-side-looking camera, a left-side-looking radar, a right-side-looking camera, and a right-side-looking radar to provide a number of signals to the first lane-aligning program and the second lane-aligning program.

23. A method according to claim 17, wherein the method is performed by a computer having a memory executing one or more programs of instructions which are tangibly embodied in a program storage medium readable by the computer.
